(19) United States
(12) Patent Application Publication
(10) Pub. No.: US 2011/0226591 A1
(43) Pub. Date: Sep. 22, 2011

(54) VERTICAL PIPE CONVEYOR

(75) Inventors: Ingolf W. Neubecker, Elizabeth, CO (US); Christof Brewka, Highlands Ranch, CO (US)

(73) Assignee: ThyssenKrupp Robins, Inc., Greenwood Village, CO (US)

(21) Appl. No.: 13/050,790

(22) Filed: Mar. 17, 2011

Related U.S. Application Data
(60) Provisional application No. 61/314,812, filed on Mar. 17, 2010.

(51) Int. Cl. B65G 15/08

(52) U.S. Cl. 198/617; 198/626.2; 198/626.4

(57) ABSTRACT

A pipe conveyor may include a conveyor belt formed into a pipe-like shape to define a space that contains material to be transported by the conveyor. Along at least a portion of the pipe conveyor, friction drive conveyors or friction tires may be positioned. The friction drive conveyors may include friction drive belts that engage the pipe conveyor belt. Via this engagement, the friction drive conveyors apply a force to the conveyor belt that moves the conveyor belt in a desired direction. Further, when the friction drive conveyors or friction tires are positioned within an inclined vertical section of the conveyor belt, the friction drive conveyors or friction tires vertically lift the pipe conveyor belt via pushing the conveyor belt in a vertical direction, thus assisting a drive pulley that vertically pulls the conveyor belt and material transported on the conveyor belt from a lower elevation to a higher elevation.

### CROSS-REFERENCE TO RELATED APPLICATIONS

This application claims the benefit, under 35 U.S.C. §119(e), of U.S. provisional application No. 61/314,812, entitled “Vertical Pipe Conveyor” and filed on Mar. 17, 2010, which is hereby incorporated by reference herein in its entirety.

### FIELD OF INVENTION

The present invention generally relates to conveyors, and more particularly to pipe conveyors.

### BACKGROUND

One type of conveyor for transporting material is a pipe conveyor, which can be used to protect the material being transported and prevent access to the material from outside sources. As such, pipe conveyors are often used in situations where spillage or dust may be an issue or where use of conventional conveyor systems may be too costly or hazardous due to environmental or population concerns. Pipe conveyors are also useful in situations in which the conveyor layout requires horizontal and/or vertical curves, especially, when the conveyor layout includes a vertical rise or fall. Conventional pipe conveyors, however, are generally limited to being used in conveyor systems with vertical angles of less than 30 degrees as measured from a horizontal axis. While some pipe conveyor designs exist that allow for pipe conveyors to rise at vertical angles greater than 30 degrees, these systems are often limited to relatively short total elevation differentials, thus limiting their ability to be used in conveyor systems with large vertical elevation gains.

### SUMMARY OF THE INVENTION

One embodiment of a conveyor system may include a pipe conveyor and at least one friction drive conveyor. The pipe conveyor may include a head end, a tail end positioned at an elevation lower than the head end, and an inclined section between the head end and the tail end. The at least one friction drive conveyor may engage the pipe conveyor within the inclined section, and the at least one friction drive conveyor may be configured to push a belt of the pipe conveyor in a direction from the tail end to the head end of the pipe conveyor.

Another embodiment of a conveyor system may take the form of a method of operating a conveyor system. The method may include transporting material from a tail end to a head end of a pipe conveyor where the head end of the pipe conveyor is at a higher elevation than the tail end of the pipe conveyor and the pipe conveyor includes an inclined section positioned between the tail end and the head end. The method may further include employing at least one friction drive conveyor that engages the pipe conveyor within the inclined section to push a belt of the pipe conveyor from the tail end to the head end of the pipe conveyor.

Yet another embodiment of a conveyor system may include a pipe conveyor and at least one friction tire. The pipe conveyor may include a head end, a tail end positioned at an elevation lower than the head end, and an inclined section between the head end and the tail end. The at least one friction tire may engage the pipe conveyor within the inclined section. The at least one friction tire may be configured to push a belt of the pipe conveyor in a direction from the tail end to the head end of the pipe conveyor.

Still yet another embodiment of a conveyor system may take the form of a second method of operating a conveyor system. The method may include transporting material from a tail end to a head end of a pipe conveyor where the head end of the pipe conveyor is at a higher elevation than the tail end of the pipe conveyor and the pipe conveyor includes an inclined section positioned between the tail end and the head end. The method may further include employing at least one friction tire that engages the pipe conveyor within the inclined section to push a belt of the pipe conveyor from the tail end to the head end of the pipe conveyor.

### BRIEF DESCRIPTION OF THE DRAWINGS

FIG. 1 shows a schematic side elevation view of a pipe conveyor system.

FIG. 2 shows a schematic cross-section of the pipe conveyor system of FIG. 1, viewed along line 2-2 in FIG. 1.

FIG. 3 shows a schematic cross-section of the pipe conveyor system of FIG. 1, viewed along line 3-3 in FIG. 1.

FIG. 4 shows a schematic cross-section of the pipe conveyor system of FIG. 1, viewed along line 4-4 in FIG. 1.

FIG. 5 shows a schematic side elevation view of a second version of a pipe conveyor system.

FIG. 6 shows a schematic cross-section of the pipe conveyor system of FIG. 5, view along line 6-6 in FIG. 5.

### DETAILED DESCRIPTION

Described herein are pipe conveyors that may be used to transport materials from one location to another location. These pipe conveyors are particularly suited for use in conveyor systems that include steep vertical angles, especially vertical angles that are greater than thirty degrees as measured from a horizontal plane. These pipe conveyors may include a conveyor belt that is formed into a pipe-like shape to define a space that contains the material to be transported by the conveyor. Along at least a portion of the pipe conveyor, friction drive conveyors or friction tires may be positioned. The friction drive conveyors may include friction drive belts that engage the pipe conveyor belt, and the friction tires may directly engage the pipe conveyor belt. Via this engagement, the friction drive conveyors or the friction tires apply a force to the conveyor belt that moves the conveyor belt in a desired direction. Further, when these friction drive conveyors or friction tires are positioned within a vertical section of the conveyor belt, the friction drive conveyors or friction tires vertically lift the pipe conveyor belt via pushing the conveyor belt in a vertical direction, thus assisting a drive pulley that vertically pulls the conveyor belt and material transported on the conveyor belt from a lower elevation to a higher elevation. Because of this assistance, a smaller drive pulley can be used in the system than would otherwise be required to lift the conveyor belt, and the material transported thereon, to the higher elevation from the lower elevation.

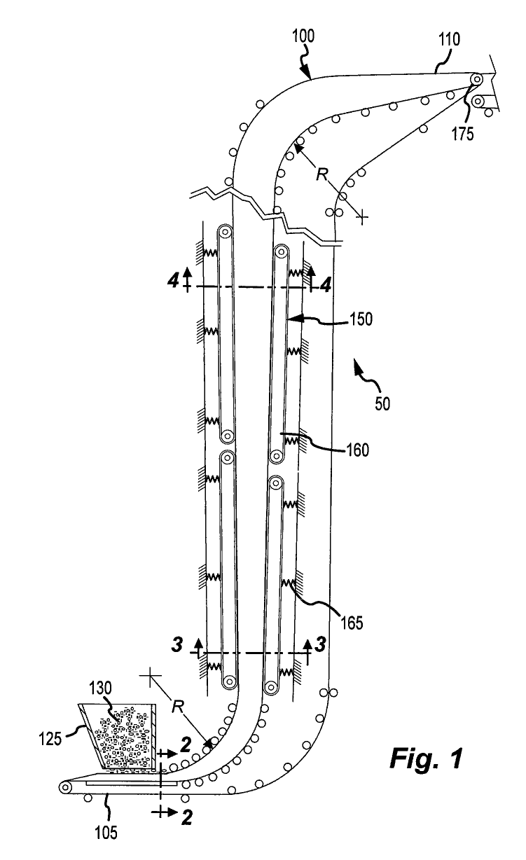

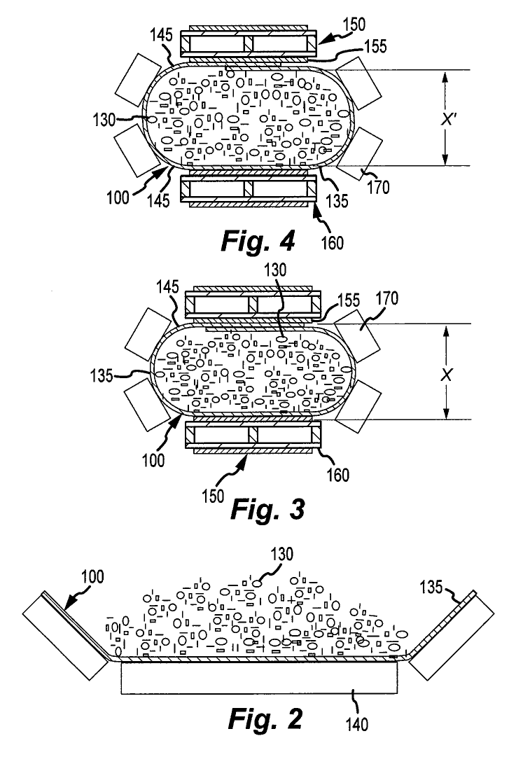

FIG. 1 shows a schematic of a pipe conveyor system. FIGS. 2-4 show schematic cross-section views of the pipe conveyor system at various locations of the pipe conveyor. With reference to FIG. 1, the pipe conveyor system 50 may include a pipe conveyor 100. The pipe conveyor 100 may include a tail end 105 and a head end 110. The head end 110 of the pipe conveyor 100 may be positioned at a higher elevation than the tail end 105. Starting from the tail end 105 of the pipe conveyor 100, the pipe conveyor 100 may include a first substantially horizontal, or sloped up to 15°, section that transitions to an inclined section. The inclined section may be substantially vertical, as shown in FIG. 1, or any other desired incline from a substantially horizontal plane. Proximate the head end 105 of the pipe conveyor 100, the inclined section of the pipe conveyor may transition to a second substantially horizontal, or sloped up to 15°, section.

A material loader 125 may be positioned proximate the tail end 105 of the pipe conveyor 100. The material loader 125 deposits material 130 onto the pipe conveyor 100 for transport from the tail end 105 to the head end 110 of the pipe conveyor 105. With reference to FIG. 2, the belt 135 of the pipe conveyor 100 may be formed into a trough or channel shape in the area where the pipe conveyor 100 receives material 130 from the material loader 125, and a slider bed 140 may be positioned under the pipe conveyor belt 135 to provide support for the pipe conveyor belt 135 as material 130 is placed onto it. After the material 130 is deposited onto the pipe conveyor 100, the pipe conveyor belt 135 may be formed into a pipe shape by overlapping the ends of the pipe conveyor belt 135, as shown for example in FIGS. 3 and 4. The pipe conveyor belt 135 is formed into this pipe shape prior to transitioning into the inclined section and maintained in this pipe shape through the inclined section. After the belt transitions from the inclined section to the second horizontal section, the belt 135 may return to its trough shape configuration, or to a flat configuration, so that the material 130 loaded onto the pipe conveyor 100 may be discharged from the pipe conveyor 100 at the head end 110 of the pipe conveyor 100. Any suitable structure system for changing the form of the belt from its trough shaped configuration to its pipe shaped configuration, and vice versa, may be utilized.

With reference to FIGS. 3 and 4, the pipe conveyor belt 135 may define an oval cross-section (as viewed along the length of the conveyor belt 135) that contains material 130 when formed into the pipe shape. This oval cross-section area may be designed for at least 95% of the cross-sectional area to be filled with material 130 transported by the pipe conveyor 100. Use of an oval cross-section provides two flat surfaces 145 for engagement with friction drive conveyors 150, as described in more detail below. Further, the oval cross-section facilitates designing a pipe conveyor 100 that defines a sufficient area for receiving material 130 to be transported by the pipe conveyor 100 while allowing for smaller radii to be used when transitioning from the horizontal to the incline sections.

Specifically, when designing a pipe conveyor 100 where the belt 135 is formed to define an oval cross-section area, the distance between the substantially parallel and linear sides of the belt 135, which is identified as X and X′ in FIGS. 3 and 4 respectively, will typically be a function of the desired radii for the transitions between the incline section and the first and second horizontal sections, which are identified as R and R′, respectively, in FIG. 1, and the required transport volume, which is typically expressed as volume per unit time. Generally, the distance X and X′ should be kept as small as possible because as the distance X and X′ decreases, smaller radii for the transitions R and R′ can be used for a given belt stiffness. Smaller radii R and R′, in turn, allow for shorter transitions between horizontal and inclined sections of the pipe conveyor 100, which can be useful when space constraints require short transitions between horizontal and inclined sections of the pipe conveyor 100. While it is generally desirable to minimize the distance X and X′, the distance needs to be large enough to define a sufficient oval cross-section area for transporting material 130 from the tail end 105 to the head end 110 of the pipe conveyor 100 at the required transport volume.

With continued reference to FIGS. 1, 3 and 4, the cross-section area defined by the pipe conveyor belt 135 may taper outward along the inclined section from the first horizontal section to the second horizontal section. The taper may be approximately 50 mm for every 10,000 mm of belt length. As the cross-section tapers outward, the overlap of the ends of the belt 135 slightly decreases and the distance between the parallel linear sides of the belt increases slightly (i.e., distance X is slightly less than distance X′). This decrease in overlap and increase in distance between the parallel sides is shown schematically in FIGS. 3 and 4. The result of these changes is the cross-section area defined by the belt 135, within the inclined section, increases from the first horizontal section to the second horizontal section. Increasing the cross-section area defined by the belt 135 by tapering it outward from the first horizontal section to the second horizontal section helps to reduce the tendency for material 130 to slide down the inclined section towards the first horizontal section. Tapering the pipe conveyor belt 135 outward also helps to press the pipe conveyor belt 135 against the one or more friction drive conveyors 150 that are placed along the inclined section of the pipe conveyor 100.

Returning to FIG. 1, one or more friction drive conveyors 150 may be positioned proximate the pipe conveyor 100 along the inclined section of the pipe conveyor 100. Each friction drive conveyor 150 may include a friction drive belt 155 and a support structure 160. The support structure 160 provides support for the friction drive belt 155. Each friction drive conveyor 150 may be positioned relative to the pipe conveyor 100 such that its respective friction drive belt 155 engages the belt 135 of the pipe conveyor 100. This engagement of the friction drive conveyors 150 with the pipe conveyor 100 results in the friction drive conveyors 150 applying pushing forces to the pipe conveyor 100. These forces help push the pipe conveyor belt 135, and any material 130 contained therein, from the first horizontal section to the second horizontal section.

The magnitude of the forces applied by a drive friction conveyor 150 for pushing the pipe conveyor belt 135 may be controlled using one or more bias members 165, such as springs. More particularly, one or more bias members 165, such as springs, may be joined to the support structure 160 of the friction drive conveyor 150. These bias members 165 may be configured to apply a force to the support structure 160 that results in the friction drive belt 155 being pressed against the pipe conveyor belt 135. As this force increases, the pushing force that can be applied to the pipe conveyor 100 increases since the friction forces applied to the pipe conveyor belt 135 by the friction drive belt 155 in a direction parallel to the longitudinal axis of the pipe conveyor belt 135 increases. In some embodiments, the bias member 165 may be omitted as the normal force generated between the pipe conveyor belt 135 and the friction drive belt 155 may be sufficient from just the outward tapering of the pipe conveyor belt 135.

With reference to FIGS. 3 and 4, the friction drive conveyors 150 may be positioned relative to the pipe conveyor 100 such that the friction drive belts 155 of the friction drive conveyors 150 engage the substantially linear sides of the pipe conveyor belt 135. Such positioning advantageously increases the contact area between the friction drive belts 155 and the pipe conveyor belt 135. Such positioning also results in the friction drive belts 155 engaging relatively flat surfaces 145 of the pipe conveyor belt 135. As shown in FIGS. 3 and 4, a friction drive conveyor 150 may be positioned on each linear side of the pipe conveyor belt 100. In some embodiments, however, friction drive conveyors 150 may be positioned on only one linear side of the pipe conveyor belt 135. In these embodiments, a pipe conveyor support structure, such as frame with a rollers, may be positioned on the other linear side of the pipe conveyor belt 135 in order to engage the other linear side and oppose the normal forces applied to the pipe conveyor 100 by the friction drive conveyors 150.

Rollers 170 may be positioned proximate of the pipe conveyor belt 135 at spaced locations along the inclined section of the pipe conveyor 100. The rollers 135 may engage the pipe conveyor belt 135 to help maintain the oval cross-section shape of the pipe conveyor belt 135. In particular, the rollers 170 may engage the curved portions of the oval cross-section of the pipe conveyor belt 135 to press the pipe conveyor belt 135 inward in order to oppose the outward pressure imposed on the pipe conveyor belt 135 by the material 130 contained in the oval cross-section area defined by the pipe conveyor belt 135.

Returning to FIG. 4, a drive pulley 175 may be positioned at the head end 110 of the pipe conveyor 100. The drive pulley 175, in conjunction with the friction drive conveyors 150, lifts the pipe conveyor belt 135, and material 130 contained therein, from the first horizontal section to the second horizontal section. Because the friction drive conveyors 150 assist the drive pulley 175 in lifting the pipe conveyor belt 135, the drive pulley 175 requires less power than would otherwise be required. Further, because less power is required for the drive pulley 175, the tension imposed on the pipe conveyor belt 135 by the drive pulley 175 is less than would otherwise be imposed. This allows for belts with lower modulus of elasticity and/or lower strength to be used for the pipe conveyor belt 135.

Advantageously, as the modulus of elasticity for the pipe conveyor belt 135 decreases, smaller radii R and R′ can be used in the transition sections of the pipe conveyor 100. Moreover, by positioning a suitable number of friction drive conveyors 150 along the length of the inclined section of the pipe conveyor 100 and appropriately biasing these conveyors 150 against the pipe conveyor 100, the power required for drive pulley 175 to lift the pipe conveyor belt 135 can be kept to a minimum regardless of the amount of total vertical distance from the first horizontal section to the second horizontal section, thus allowing the modulus of elasticity of the pipe conveyor belt 135 to be kept low enough to permit the pipe conveyor 100 to be used for vertical lift distances and/or inclines that would not be possible with conventional pipe conveyors. Moreover, in some embodiments, the required modulus of elasticity may be sufficiently low enough that fabric conveyor belts that do not include any steel reinforcement may be utilized.

In operation, material 130 is deposited on the pipe conveyor 100 from the material loader 125 at the tail end 105 of the pipe conveyor 100. After depositing the material 130 onto the pipe conveyor 100, the ends of the pipe conveyor belt 135 are overlapped to define an oval cross-section area that contains the material 130. After the ends of the pipe conveyor belt 135 are overlapped, the pipe conveyor 100 passes through a transition section that changes the direction of travel of the pipe conveyor 100 from substantially horizontal to either vertical or a combination of vertical and horizontal (i.e., inclined). Friction drive conveyors 150 push the pipe conveyor 100, and the material 130 contained therein, upward towards a second transition area were the pipe conveyor 100 transitions from traveling in a vertical or inclined direction back to a substantially horizontal direction of travel.

As the pipe conveyor 100 nears the second transition area, the drive pulley 175 pulls the pipe conveyor 100 through the final vertical distance until the pipe conveyor 100 is again traveling in a substantially horizontal direction. After the pipe conveyor 100 completes the transition from a vertical or inclined direction of travel to a horizontal direction of travel, the oval cross-section is changed to a trough or flat configuration by undoing the overlap of the ends of the pipe conveyor belt 135. Material 130 is then removed from the pipe conveyor belt 135 and the pipe conveyor belt 135 returns to the tail end 105 of the pipe conveyor 100. In some embodiments, the pipe conveyor belt 135 may also transport material 130 from the head end 110 to the tail end 105 of the pipe conveyor 100 as it returns to the tail end 105 of the pipe conveyor 100. In such embodiments, the pipe conveyor belt 135 may be configured to define an oval or other cross-section for containing material 130 transported from the head end 110 to the tail end 105 of the pipe conveyor 100.

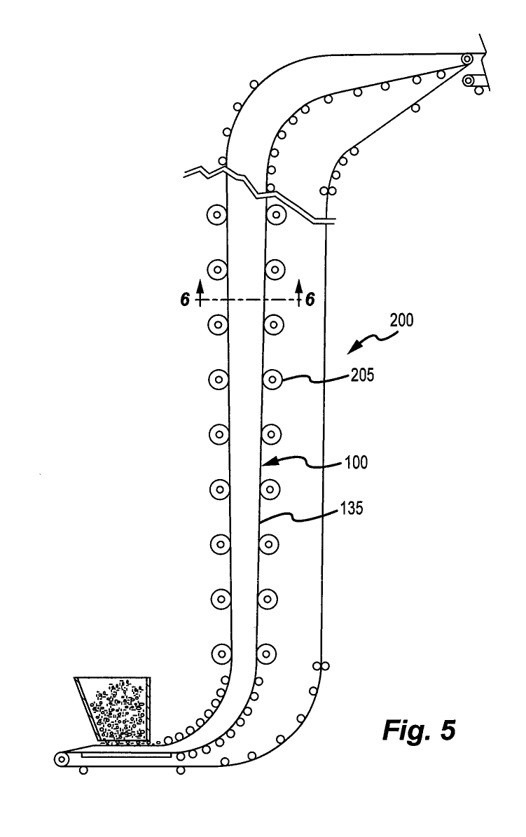

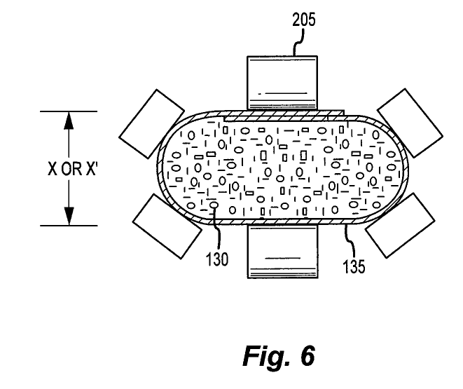

FIG. 5 shows a schematic elevation view of a second version of a pipe conveyor system 200. FIG. 6 shows a schematic cross-section view of the pipe conveyor system of FIG. 5. The second pipe conveyor system 200 is similar to the first pipe conveyor system 50 and operates in a similar manner except one of more of the friction drive conveyors 150 may be replaced by friction tires 205 or the like. The friction tires 205 serve a purpose similar to the friction drive conveyors 150. In particular, the friction tires 205 help to lift the pipe conveyor 100 while also helping to maintain the shape of the conveyor 100.

The friction tires 205 may be installed in pairs on opposite sides of the pipe conveyor belt 135. Each friction tire 205 may be configured to engage a substantially flat or linear side of the oval-shaped pipe conveyor belt 135 and may be driven by a shaft mounted variable speed electric motor reducer. Each pair of friction tires 205 may be positioned along the length of the pipe conveyor belt 135 at a predetermined spacing relative to other pairs of friction tires 205. This spacing may be a function of the total amount of lift friction forces required divided by the installed drive power per pair of friction tires 205.

Each friction tire 205 may be filled with an air pressure that may be selectively adjusted to change the spring-like force applied by the friction tire 205 to the pipe conveyor belt 135, and each friction tire 205 may have a different air pressure than the other friction tires 205. The air pressure may be set based upon one or more factors, including, but not limited to, the material properties of the material 130 carried by the pipe conveyor 100, the lifting height between adjacent sets of friction tires 205, or the vertical location of the friction tire 205. Generally, the air pressure may be set within a range that allows the friction tire 205 to flatten the engaged surface of the pipe conveyor belt 135 and/or to provide sufficient contact force between the pipe conveyor belt 135 and the friction tire 205 while minimizing an amount that the cross-section shape of the pipe conveyor belt 135 is indented by the friction tire 205. In some embodiments, the air pressure range may be relatively low (approximately 15 pounds per square inch (“p.s.i.”) to approximately 20 p.s.i.). In other embodiments, the air pressure may be less than 15 p.s.i. or greater than 20 p.s.i.

For reasons of economy and mechanical advantage, each friction tire 205 may have a diameter that is kept as small as possible while also providing a sufficiently firm contact pressure that keeps the cross-sectional area of the pipe conveyor belt 135 from expanding under the load of material 130 contained within the pipe conveyor belt 135. In some embodiments, the ratio of the tire diameter to the distance X (or X′) defined by the pipe conveyor belt 135 may be approximately 1.2:1. The foregoing example is merely illustrative of one possible size for the tire diameter and is not intended to require or imply that the tire diameter must be sized at this ratio relative to the size of the pipe conveyor belt 135.

While the friction drive conveyors and friction tires have been described and shown as used within the inclined section of the pipe conveyor, friction drive conveyors and/or friction tires may also be used in the horizontal sections of the pipe conveyor. Further, while FIGS. 1 and 5 show the pipe conveyor as having one inclined section and two horizontal sections, the system described above could be used with pipe conveyor systems that have multiple inclined and horizontal sections.

All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A conveyor system, comprising:
a pipe conveyor including a head end, a tail end positioned at an elevation lower than the head end, and an inclined section between the head end and the tail end;
at least one friction drive conveyor that engages the pipe conveyor within the inclined section; and
the at least one friction drive conveyor configured to push a belt of the pipe conveyor in a direction from the tail end to the head end of the pipe conveyor.

2. The conveyor system of claim 1, wherein the at least one friction drive conveyor comprises at least one pair of friction drive conveyors positioned on opposite sides of the belt of the pipe conveyor.

3. The conveyor system of claim 1, further comprising:
at least one bias member that presses the at least one friction drive conveyor against the pipe conveyor.

4. The conveyor system of claim 1, wherein the at least one friction drive conveyor includes a friction drive conveyor belt that engages the belt of the pipe conveyor.

5. The conveyor system of claim 4, wherein the at least one friction drive conveyor further includes a support structure configured to support the friction drive conveyor belt.

6. The conveyor system of claim 1, wherein a portion of the belt of the pipe conveyor defines an oval cross-section area configured to receive material therein.

7. The conveyor system of claim 6, wherein the portion of the belt defining the oval cross-section area includes a substantially flat surface and the at least one friction drive conveyor engages the substantially flat surface.

8. The conveyor system of claim 6, wherein the oval-cross section defined by the portion of the belt tapers outward in the inclined section when moving in a direction from the tail end to the head end of the conveyor.

9. The conveyor system of claim 6, further comprising material contained within the oval cross-section area, and the material substantially fills the oval cross-section area.

10. The conveyor system of claim 1, further comprising a material loader positioned proximate the tail end of the conveyor and configured to deposit material onto the belt of the pipe conveyor.

11. The conveyor system of claim 1, further comprising a slider bed positioned under the belt of the pipe conveyor proximate the tail end of the pipe conveyor.

12. The conveyor system of claim 1, wherein the inclined section is substantially vertical.

13. The conveyor system of claim 1, wherein the inclined section inclines at an angle greater than 30 degrees as measured from a horizontal plane.

14. The conveyor system of claim 1, further comprising a transition from a first substantially horizontal section to the inclined section.

15. The conveyor system of claim 14, further comprising a transition from the inclined section to a second substantially horizontal section.

16. The conveyor system of claim 1, further comprising a drive pulley positioned proximate the head end of the pipe conveyor and operatively associated with the belt.

17. A method of operating a conveyor system, comprising:
transporting material from a tail end to a head end of a pipe conveyor where the head end of the pipe conveyor is at a higher elevation than the tail end of the pipe conveyor and the pipe conveyor includes an inclined section positioned between the tail end and the head end; and
employing at least one friction drive conveyor that engages the pipe conveyor within the inclined section to push a belt of the pipe conveyor from the tail end to the head end of the pipe conveyor.

18. The method of claim 17, further comprising employing at least one bias member to press the at least one friction drive conveyor against the pipe conveyor.

19. The method of claim 17, further comprising overlapping the ends of a portion of the belt to define an oval cross-section area for containing the material.

20. The method of claim 19, wherein the portion of the belt defining the oval cross-section area includes a substantially flat surface, and the at least one friction drive conveyor engages the substantially flat surface.

21. The method of claim 17, further comprising employing a material loader positioned proximate the tail end of the pipe conveyor to load material onto the pipe conveyor.

22. The method of claim 17, wherein the inclined section is substantially vertical.

23. The method of claim 17, further comprising transitioning the pipe conveyor from a first substantially horizontal section to the inclined section.

24. The method of claim 23, further comprising transitioning the pipe conveyor from the inclined section to a second substantially horizontal section.
